(19) United States
(12) Patent Application Publication
(10) Pub. No.: US 2022/0061266 A1
(43) Pub. Date: Mar. 3, 2022

(54) Animal Feeding Apparatus

(71) Applicants: Steven Flaming, Jay, OK (US); Teresa Flaming, Jay, OK (US)

(72) Inventors: Steven Flaming, Jay, OK (US); Teresa Flaming, Jay, OK (US)

(21) Appl. No.: 17/207,865

(22) Filed: Mar. 22, 2021

Related U.S. Application Data
(60) Provisional application No. 63/070,307, filed on Aug. 26, 2020.

(51) Int. Cl. A01K 5/02

(52) U.S. Cl. CPC A01K 5/0225

(57) ABSTRACT

A feeding apparatus for deer and other large wildlife. The feeding apparatus comprises a generally cylindrical feeding chamber with a splitter positioned within the feeding chamber for directing a flow of feed. The feeding apparatus further comprises a plurality of hollow tubular legs that penetrate the feeding chamber through openings positioned to allow the flow of feed out of the feeding chamber and into each leg. A feed pan is connected to each leg through a feed path opening cut in the outward facing side of each leg. Each feed pan directs the flow of feed out of each leg vis a feed path diverter and into a pan base for consumption by the deer.

### CROSS-REFERENCE TO RELATED APPLICATION

The present application claims priority to, and the benefit of, U.S. Provisional Application No. 63/070,307, which was filed on Aug. 26, 2020 and is incorporated herein by reference in its entirety.

### FIELD OF THE INVENTION

The present invention relates generally to an apparatus for feeding animals, and more specifically to a gravity-fed feeding apparatus for deer, other wild or domesticated animals. Accordingly, the present specification makes specific reference thereto. However, it is to be appreciated that aspects of the present invention are also equally amenable to other like applications, devices and methods of manufacture.

### BACKGROUND

People may enjoy feeding larger animals, such as deer, moose, elk, or the like on their properties. Hunters may also use feeders to attract and bait game animals. Farmers and ranchers may use feeders in large fenced game pastures to provide feed to domesticated stock animals as well. These animal feeders promote wildlife preservation and allow people the opportunity to observe nature that they may otherwise be unable to see.

Wild animal feeders are tools for creating interest for hunters, wildlife enthusiasts, and animal lovers. Providing a consistent food supply, especially during the winter months, help deer and other wildlife survive cold temperatures and snowfall that limit access to normal food supplies. Current feeders have many limitations. The feeder must be large enough to hold a sufficient supply of feed. In addition, the feeder must be weatherproof and varmint resistant. Finally, the feeder must be sturdy enough not to get knocked over by bad storms, nuisance animals, or by large animals intended to be fed.

In this manner, the improved animal feeding apparatus of the present invention accomplishes all of the forgoing objectives, thereby providing an easy solution to feed deer and other large animals. A primary feature of the present invention a gravity-fed feeder that does not require a power source. The improved feeding apparatus of the present invention is capable of providing food for deer and other large wildlife without the need to tend to constantly tend the feeder and refill it at specific intervals throughout the day.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a feeding apparatus for providing feed to animals. The feeding apparatus is configured to distribute feed via a gravity-fed flow path out of the feeding apparatus. The feeding apparatus comprises a feed chamber and a plurality of hollow legs. The feed chamber comprises a cylindrical sidewall and a base. A lid is attached to an open top of the cylindrical sidewall. The lid is hinged an may comprise a gasket for creating a weather-tight seal. The feed chamber further comprises a plurality of feed dispensing openings. Each of the feed dispensing openings are rectangular openings through the cylindrical sidewall near the base.

The feeding apparatus further comprises a splitter. The splitter may be generally conical or pyramidal in shape and is positional within the feed chamber resting on the base. The splitter is configured to uniformly direct the feed stored in the feed chamber toward and out of each of the feed dispensing openings in the feed chamber.

The feeding apparatus further comprises a plurality of attachment plates. Each attachment plate is slightly curved in shape to mate flush with the cylindrical sidewall of the feed chamber. Each attachment plate comprises a generally rectangular center hole sized the same as each of the feed dispensing openings. Each attachment plate is attachable to the cylindrical sidewall with mechanical fasteners.

Each of the plurality of hollow legs is angularly attached to the cylindrical sidewall so that the feeding apparatus is stabilized in a pyramidal configuration. Each hollow leg is in open communication with an interior of the feed chamber. Each hollow leg comprises a feed chamber attachment end angled to fit the center hole of the respective attachment plate. Each feed attachment end is attached to the cylindrical sidewall via the respective attachment plate with an open feed path from the interior of the feed chamber, through the respective center hole of the attachment plate, and into an interior of the respective hollow leg. A ground engaging end of each hollow leg stabilizes the feeding apparatus.

The feeding apparatus further comprises a plurality of feed pans. Each feed pan penetrates one of the hollow legs through a feed pan opening in each hollow leg. Each feed pan opening is generally square in configuration and is located along a length on an outward facing side of the respective hollow leg. Each feed pan is configured to penetrate the respective hollow leg through the feed pan opening and direct the flow of feed exteriorly out of an interior of the hollow leg and into the feed pan. Each feed pan comprises a feed path diverter. The feed path diverter extends through the feed path opening at an angle. Each feed pan further comprises a pan base surrounded by a pan sidewall creating a receptacle to hold the feed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a feeding apparatus of the present invention for feeding animals in accordance with the disclosed architecture;

FIG. 2 illustrates a perspective view of one potential embodiment of the feeding apparatus of the present invention in accordance with the disclosed architecture and being used to feed a deer;

FIG. 3 illustrates an overhead view of one potential embodiment a splitter positioned within an interior of a feed chamber of the feeding device of the present invention in accordance with the disclosed architecture;

FIG. 4 illustrates a perspective view of one potential embodiment of a removable top portion of the feeding apparatus of the present invention in accordance with the disclosed architecture;

FIG. 5 illustrates a perspective view of one potential embodiment of a feed dispensing opening in the feed chamber of the feeding apparatus of the present invention in accordance with the disclosed architecture;

FIG. 6 illustrates an overhead perspective view of one potential embodiment of a plurality of legs attached to one of a plurality of attachment plates of the feeding apparatus of the present invention in accordance with the disclosed architecture;

FIG. 7 illustrates a back side perspective view of one potential embodiment of the plurality of legs attached to one of the plurality of attachment plates of the feeding apparatus of the present invention in accordance with the disclosed architecture;

FIG. 8 illustrates a perspective view of one potential embodiment of an interior feed path and a feed pan opening in one of the plurality of legs of the feeding apparatus of the present invention in accordance with the disclosed architecture;

FIG. 9 illustrates a perspective view of one potential embodiment of the plurality of attachment plates of the feeding apparatus of the present invention in accordance with the disclosed architecture;

FIG. 10 illustrates a perspective view of one potential embodiment of a plurality of feed pans of the feeding apparatus of the present invention in accordance with the disclosed architecture; and

FIG. 11 illustrates a perspective view of one potential embodiment of a plurality of feed pans of the feeding apparatus of the present invention attached to one of the plurality of legs in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a gravity-fed deer feeder featuring four feeding trays, that enable deer feed to be dispensed into the four individual trays around the base. A splitter at the bottom of the base separates and directs the feed into each of the four trays without the need for additional human intervention. The feeder may use a 55 gallon drum with four attached legs. Each leg is hollow and penetrates the drum to receive a flow of feed from the splitter. The trays penetrate into the legs to redirect the feed out of the legs and into the trays.

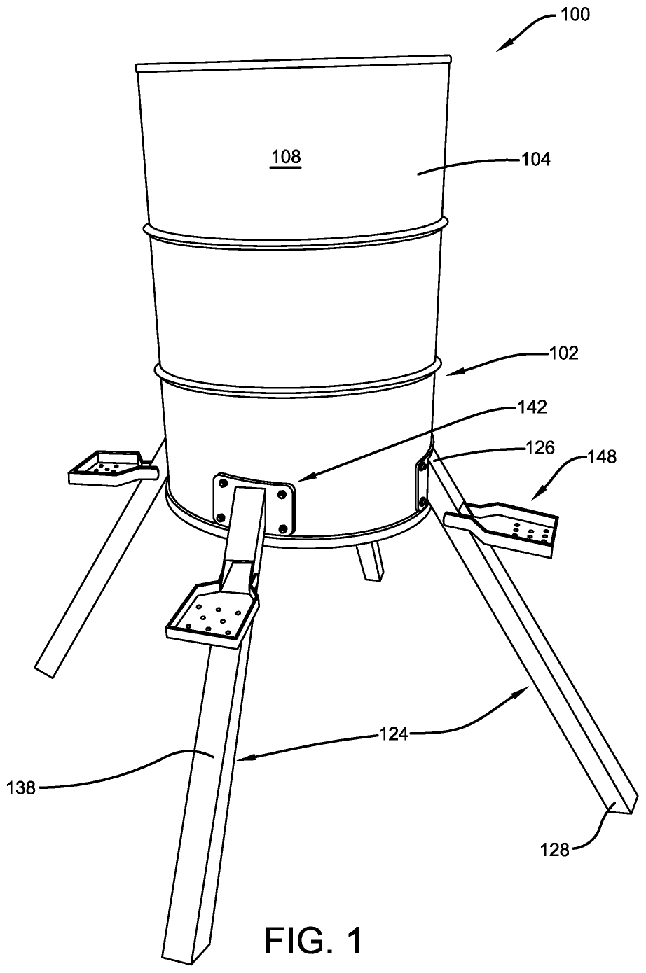

Referring initially to the drawings, FIGS. 1-11 illustrates a feeding apparatus 100 for providing feed to an animal. The feeding apparatus 100 is configured to distribute feed via a gravity-fed flow path out of the feeding apparatus to a large animal, such as a deer as illustrated in FIG. 2. The feeding apparatus 100 comprises a feed chamber 102 and a plurality of hollow legs 124. The feed chamber 102 is configured to store a quantity of feed, such as corn or other animal feed. The plurality of hollow legs 124 are positioned to support the feeding apparatus 100 in a generally pyramidal configuration so that it will be stable.

The feed chamber 102 comprises a cylindrical sidewall 104 and a base 120. The cylindrical sidewall 104 comprises an interior facing surface 106 and an exterior facing surface 108. The feed chamber 102 is typically metal or heavy plastic in construction and may be manufactured from a 55 gallon metal drum. A viewing window (not shown) may be cut into the cylindrical sidewall 104 for viewing how much feed is left in the feed chamber 102. The viewing window may be a translucent plastic window positioned in the cylindrical sidewall 104 so that the user does not have to open the feed chamber 102 unnecessarily to check the level of feed.

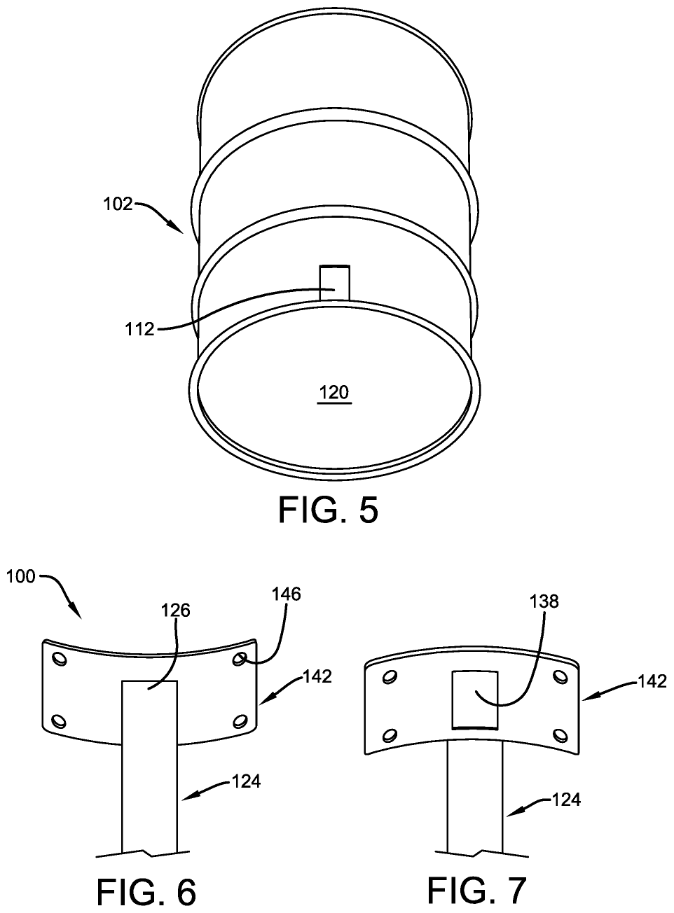

As illustrated in FIG. 4, the feed chamber 102 further comprises a lid 114. The lid 114 is generally round in shape and configured to fit an open top of the cylindrical sidewall 104. The lid 114 may be attached to the cylindrical sidewall 104 via a hinge 116, a ring clamp (not shown), a locking-lever ring clamp (not shown), or the like. Alternatively, the lid 114 may rest in place by gravity or have a screw thread. The lid 114 may comprise a gasket 118 for creating a weather-tight seal around a perimeter of the open top of the cylindrical sidewall 104. As illustrated in FIG. 5, the feed chamber 102 further comprises a plurality of feed dispensing openings 112. Each of the feed dispensing openings 112 are generally rectangular shaped openings in the cylindrical sidewall 104 near the base 120 of the feed chamber 102. The feed dispensing openings 112 permit the flow of feed out of the feed chamber 102 into each of the respective hollow legs 124.

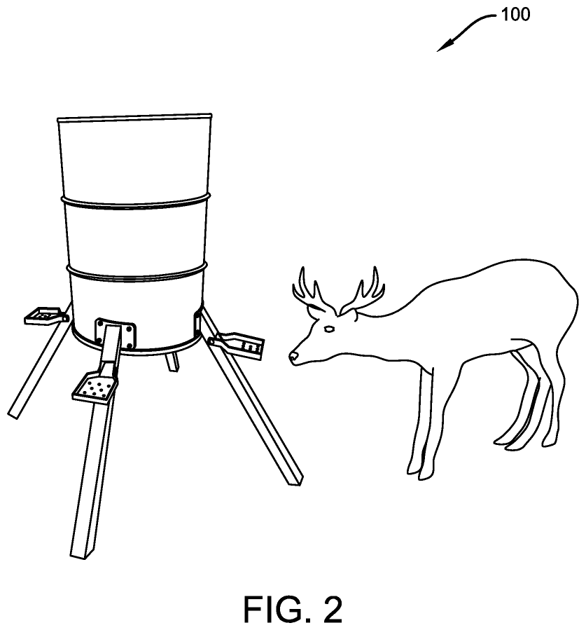

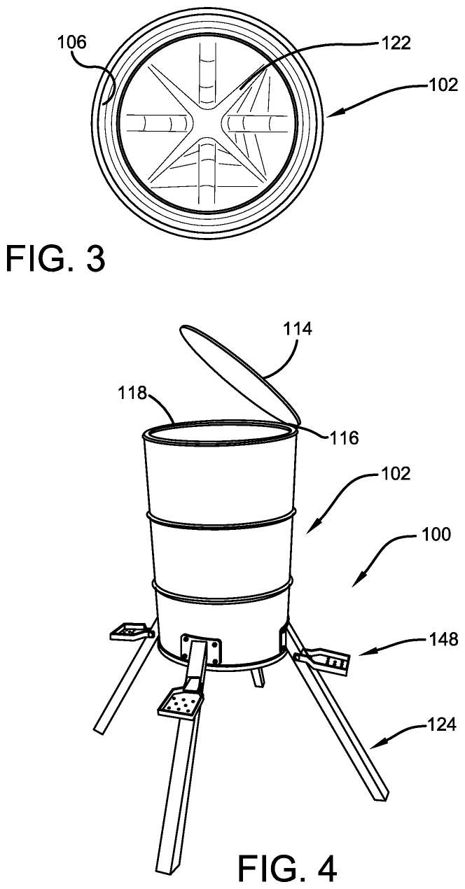

As illustrated in FIG. 3, the feeding apparatus 100 further comprises a splitter 122. The splitter 122 is a generally conical or pyramidal in shape and is positional within the feed chamber 102 resting on the base 120. The splitter 122 is configured to uniformly direct feed stored in the feed chamber 102 toward and out of each of the feed dispensing openings 112.

As illustrated in FIGS. 6, 7, and 9, the feeding apparatus 100 further comprises a plurality of attachment plates 142. The attachment plates 142 are typically metal plates. Each attachment plate 142 is slightly curved in shape to mate flush with the exterior surface 108 of the cylindrical sidewall 104 of the feed chamber 102. Each attachment plate 142 comprises a generally rectangular center hole 144 sized the same as each of the feed dispensing openings 112. Each attachment plate 142 is attachable to the cylindrical sidewall 108 with mechanical fasteners through a plurality of fastening holes 146.

As further illustrated in FIGS. 1 and 6-8, each of the plurality of hollow legs 124 is in open communication with the interior of the feed chamber 102. Each hollow leg 124 comprises a feed chamber attachment end 126 and a ground engaging end 128. The plurality of hollow legs 124 are generally square in configuration and may be constructed from square metal tubing.

Each feed chamber attachment end 126 is beveled and angularly attached to the cylindrical sidewall 104 so that the feeding apparatus 100 is stabilized in a pyramidal configuration. Each feed chamber attachment end 126 is sized to fit the center hole 144 of the respective attachment plate 142. Each feed attachment end 126 is attached to the cylindrical sidewall 104 via the respective attachment plate 142 with an open feed path from the interior of the feed chamber 102, through the respective center hole 144 of the attachment plate 142, and into an interior feed path 138 of the respective hollow leg 124.

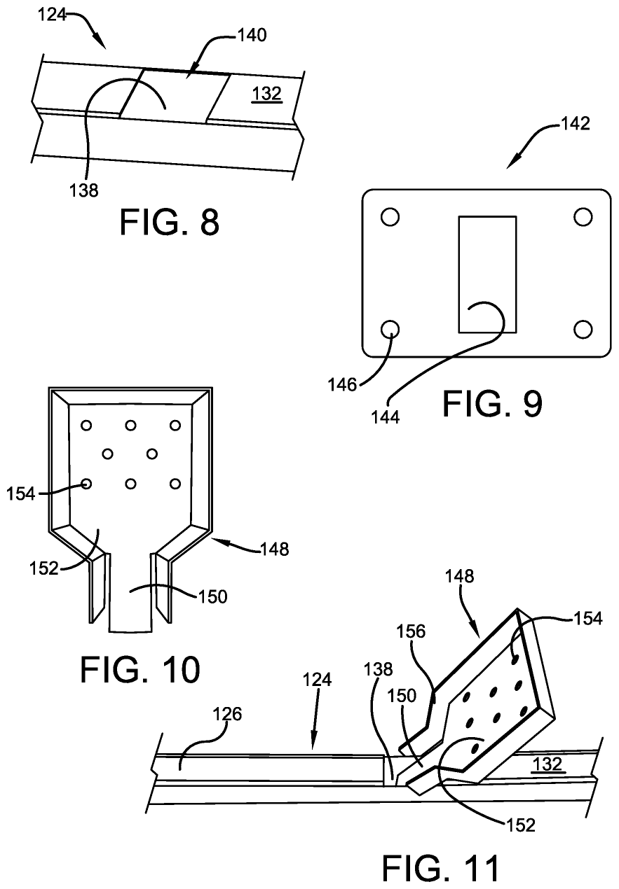

As illustrated in FIGS. 1, 10, and 11, the feeding apparatus 100 further comprises a plurality of feed pans 148. Each feed pan 148 penetrates one of the hollow legs 124 through a feed pan opening 140 cut into each hollow leg 124. As illustrated in FIG. 8, each feed pan opening 140 is generally square in configuration and is located along a length on an outward facing side 132 of the respective hollow leg 124. Each feed pan 148 is configured to penetrate the respective hollow leg 124 through the feed pan opening 140 and direct the flow of feed exteriorly out of an interior of the hollow leg 124 and into the feed pan 148.

Each feed pan 148 comprises a feed path diverter 150. The feed path diverter 150 extends through the feed pan opening 140 and into an interior of each hollow leg 124 at an angle forming a ramp to direct the flow of feed out of the respective leg 124. Each feed pan 148 further comprises a pan base 152 surrounded by a pan sidewall 156 creating a receptacle to hold the feed. Each pan base 152 may comprise a plurality of drain holes 154 sized to drain water, but small enough so that the feed is retained in the pan base 152. Each pan base 152 angles away from the respective feed path diverter 150 to be oriented substantially parallel with the ground.

To use the feeding apparatus 100, the user opens the lid 114 and fills the feed chamber 102 with feed. The feed flows over the splitter 122 and is uniformly directed toward each of the feed dispensing openings 112 in the cylindrical sidewall 104. The feed then flows by gravity through each hollow leg 124 and into each of the feed pans 148 in an even distribution so that the feed is exteriorly available for an animal. The feeding apparatus 100 is varmint proof and weatherproof as the feed is stored inside the feed chamber 102 with the lid 114 in place and no motor is required to distribute the feed.

Notwithstanding the forgoing, the improved feeding apparatus 100 can by any suitable size, shape, and configuration as is known in the art without affecting the overall concept of the invention, provided that it accomplishes the above stated objectives. One of ordinary skill in the art will appreciate that the shape and size of the feeding apparatus 100 and its various components, as show in the FIGS. Are for illustrative purposes only, and that many other shapes and sizes of the feeding apparatus 100 are well within the scope of the present disclosure. Although dimensions of the feeding apparatus 100 and its components (i.e., length, width, and height) are important design parameters for good performance, the feeding apparatus 100 and its various components may be any shape or size that ensures optimal performance during use and/or that suits user need and/or preference. As such, the feeding apparatus 100 may be comprised of sizing/shaping that is appropriate and specific for its use.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A feeding apparatus comprising:
a feed chamber;
a splitter positional within the feed chamber;
a plurality of hollow legs in communication with an interior of the feed chamber; and
a plurality of feed pans, each feed pan penetrating into one of the hollow legs.

2. The feeding apparatus of claim 1, wherein feed stored in the feed chamber is directed out of the feed chamber, through each hollow leg, and into each feed pan via gravity.

3. The feeding apparatus of claim 1, wherein feed stored in the feed chamber is uniformly distributed to each of the plurality of feed pans.

4. The feeding apparatus of claim 1, wherein the splitter is pyramidal in shape.

5. The feeding apparatus of claim 1, wherein the splitter in conical in shape.

6. The feeding apparatus of claim 1, wherein the each of the hollow legs is constructed from square tubing.

7. The feeding apparatus of claim 1, wherein the feed chamber comprises a cylindrical sidewall and a hinged lid.

8. The feeding apparatus of claim 1, wherein the feed chamber is constructed from a 55 gallon metal drum.

9. The feeding apparatus of claim 1, wherein each feed pan comprises a feed path diverter extending into an interior of one of the hollow legs.

10. The feeding apparatus of claim 1, wherein each feed pan comprises a pan base for collecting feed.

11. A feeding apparatus comprising:
a cylindrical feed chamber for storing feed;
a splitter positional within the feed chamber;
a plurality of hollow legs in open communication with an interior of the feed chamber; and
a plurality of feed pans, each feed pan penetrating into one of the hollow legs and configured to direct a flow of the stored feed exteriorly.

12. The feeding apparatus of claim 11, wherein the cylindrical feed chamber comprises a gasketed hinged lid.

13. The feeding apparatus of claim 11, wherein the cylindrical feed chamber comprises a plurality of feed dispensing openings for permitting the flow of feed into each of the hollow legs.

14. The feeding apparatus of claim 11, wherein each feed pan comprises a pan base comprising a plurality of drainage holes.

15. The feeding apparatus of claim 11, wherein each feed pan comprises a pan base for collecting feed directed out of the feed chamber and through one of the hollow legs.

16. A feeding apparatus comprising:
a cylindrical feed chamber for storing feed;
a splitter positional within the feed chamber;
a plurality of hollow legs in open communication with an interior of the feed chamber;
a plurality of attachment plates, each attachment plate configured to attach one of the hollow legs to the cylindrical feed chamber; and
a plurality of feed pans, each feed pan penetrating into one of the hollow legs and configured to direct a flow of the stored feed exteriorly.

17. The feeding apparatus of claim 16, wherein each feed pan comprises a feed path diverter extending into an interior of one of the hollow legs and a pan base for collecting the flow of stored feed.

18. The feeding apparatus of claim 17, wherein each pan base is oriented substantially parallel with the ground.

19. The feeding apparatus of claim 16, wherein the cylindrical feed chamber comprises a plurality of feed dispensing openings for permitting the flow of feed into each of the hollow legs.

20. The feeding apparatus of claim 16, wherein the feed stored in the feed chamber is uniformly directed out of the feed chamber, through each hollow leg, and into each feed pan.
